(19) United States
(12) Patent Application Publication
(10) Pub. No.: US 2010/0069245 A1
(43) Pub. Date: Mar. 18, 2010

(54) Method and Composition for Clearing Sewer Lines of Roots Utilizing Herbicides and Bacteria

(76) Inventors: Fred Richard Scholer, East Windsor, NJ (US); Hsing-Hui Yu, Kearny, NJ (US); Raj Mehta, Norristown, PA (US)

Correspondence Address: IP Patent Docketing;K&L GATES LLP, 599 Lexington Avenue, 33rd Floor, New York, NY, 10022-6030, US

(21) Appl. No.: 12/625,289

(22) Filed: Nov. 24, 2009

Related U.S. Application Data
(63) Continuation of application No. 11/749,012, filed on May 15, 2007.

(51) Int. Cl. A01N 63/00; A01P 13/00

(52) U.S. Cl. 504/117

(57) ABSTRACT

A foaming root destroyer is provided that utilizes a combination of herbicides and bacteria to inhibit and destroy the roots and fine root hairs intruding into underground discharge waste pipe systems. Furthermore, the foaming root destroyer can work over a longer period of time providing an enzymatic process to degrade and eliminate the dead root mass in the sewer line.

### BACKGROUND OF THE INVENTION

The invention relates to a root destroyer composition and method of use, and in particular to a foaming combination of a bacterial and herbicidal system and method of use that can be used to destroy root masses found in sewer lines.

Drain and sewer lines can become damaged and blocked by roots intruding into the underground pipe system. Underground sewer lines commonly develop cracks and openings either within the pipe or more frequently, at the joints connecting pipes. Openings can occur because of the movement of the pipe through physical disturbances or through the settling of the earth supporting the pipe. Trees send fine tendrils to find nutrients and water. These openings allow for the intrusion of roots seeking a supply of water. Once a fine root hair enters the sewer line through a tiny crack, the crack only grows bigger as the root hair grows and continues to damage the pipe. Once an opening occurs and roots develop to block the sewer line, the blockage or partial blockage must be removed. This is commonly done mechanically or chemically with a variety of chemicals. If the damages done by the roots are too severe, the pipe line would often need to be entirely replaced. Therefore, it is valuable to clear the line of fine hairs and small roots before too much damage is done.

Various active ingredients have been formulated and used to treat root blockage, including using copper sulfate and herbicides. However, none of these have proven to be fully satisfactory.

Copper sulfate is a naturally occurring inorganic salt. It is often used as a fungicide to control bacterial and fungal diseases or as an herbicide in irrigation and municipal water treatment systems. Generally, when using copper (II) sulfate (CuSO₄), copper sulfate crystals are introduced into the sewer line through the toilet. The copper sulfate crystals dissolve partially in the water and travel downstream to the location of the root blockage. Because copper has an inhibitive effect on root growth, root hairs that are contacted by it tend to stop growing. However, while some root hairs are killed, others commonly continue to grow and expand. This is because the copper sulfate finally does not reach all of the root hairs throughout the three-dimensional cross-section of the sewer pipe. Larger, undissolved copper sulfate crystals can become embedded in the root mass leading to a longer killing cycle. However, this approach has the similar downfall that the copper sulfate herbicide interacts with the root mass only through those areas in direct contact with the water. Therefore, those root hairs not in direct contact with the herbicide continue to grow.

To increase the root exposure to active ingredients by increasing the contact areas within the three-dimensional cross-section of a pipe, another approach is used, which involves the use of chemicals in combination with a foaming system as taught in U.S. Pat. Nos. 5,062,878 ('878), and 5,069,706 ('706). In addition, U.S. Pat. No. 5,264,146 ('146) teaches the use of a foaming agent and either caustic, solvents or bacteria to digest grease or organic matter. U.S. Pat. No. 5,630,883 ('883) discloses the use of percarbonate salts with oxidizing agents to generate foam. The contents of these patents are incorporated herein by reference.

One major drawback shared by the '878 and the '706 patents is that the foaming agent consists of a gas releasing compound and a detergent. The gas releasing compound is a two part system consisting of a bicarbonate salt and a dry acid, such as sulfamic acid. This approach requires the active ingredients to be separated by an artificial boundary within the container and protected against moisture to prevent premature reaction of the ingredients. Because of the nature of the components and the packaging, all of the contents of the bottle are typically used for a single application. Another limitation of the disclosed foaming systems is that the formulation should be premixed and dissolved in water in a large container prior to adding the chemicals into the toilet. Once the dry acid and bicarbonate come in contact with water in the large container, the reaction begins to generate foam. The foaming solution must be quickly introduced through the toilet into the pipe system to destroy the roots. This process is cumbersome to perform and can cause safety concerns. For example, the process involves exposing the user to the active herbicide.

Another disadvantage is that in order to have sufficient shelf life of the formulation, the dry components must be packaged in such away that the acid lies at the bottom of the container, followed by the gas releasing compound followed by the herbicide mixture.

Accordingly, it is desirable to provide a root destroyer system that overcomes drawbacks of the prior art.

### SUMMARY OF THE INVENTION

Generally speaking, in accordance with the invention, a foaming root destroyer is provided. The destroyer can utilize herbicides and/or bacteria to inhibit and destroy the roots and fine root hairs intruding into underground discharge waste pipe systems. If employing both, the foaming root destroyer can work over a longer period of time providing an enzymatic process to degrade and eliminate the dead root mass in the sewer line. Particularly useful bacteria are also provided.

A system in accordance with the invention can comprise a blend of highly foaming surfactants and additives which promote foaming as well as the active ingredients' ability to adhere to the organic root masses. The active ingredients can include herbicides, such as dichlobenil, and bacteria. Bacteria in accordance with preferred embodiments of the invention can be cultivated to survive in the environment generated by the herbicide. Herbicides appropriate to the application include those already approved for sewer line applications by the E.P.A. The herbicides provide an immediate kill system to destroy the roots of the root mass. The bacteria provide a long term solution for digesting and removing the dead root system. In addition, the enzymes generated by the bacteria provide a continuous means to degrade future or remnant root systems. The formulation can also contain inert fillers to allow uniform dispersion of the active ingredients throughout the formulated product.

The components can be mixed as a dry blend. In the preferred embodiments of the invention, the ingredients can be packaged in either 2, 4, 8 ounce or other size bags. In a preferred embodiment of the invention, the bags can be water soluble. The use of the water-soluble bags eliminates the need for any contact with the formulation by the user. Once introduced into the toilet, the water-soluble bag quickly dissolves, dispersing the dry formulation into the water. Flushing the toilet generates turbulent mixing. This causes the foaming surfactant system to activate creating a space filling foam capable of carrying both the herbicide and bacteria to the root location. The foaming action allows the active ingredients to come in contact with the root mass throughout the dimensions of the waste discharge pipe.

Accordingly, it is an object of this invention to provide an improved system for inhibiting, destroying and degrading the growth of roots, root hairs and root masses in sewer lines.

Another object of this invention is to provide an improved term root destroyer capable of serving as an emergency cleaner.

Another object of this invention is provide an improved short-term and long-term method of treating roots in sewer lines that would be ready-to-use and non-hazardous to its users.

Yet another objective of the invention is to provide an economically affordable and user-friendly solution to remove roots.

Still other objects and advantages of the invention will in part be obvious and will in part be apparent from the specification and drawings.

The invention accordingly comprises the several steps and the relation of one or more of such steps with respect to each of the others, and the composition possessing the features, properties, and relation of components, which are exemplified in the following detailed disclosure, and the scope of the invention will be indicated in the claims.

### BRIEF DESCRIPTION OF DRAWINGS

For a fuller understanding of the invention, reference is had to the following description taken in connection with the accompanying drawing, in which:

FIG. 1 is a picture of a mung bean in agar with and without exposure to a root destroyer in accordance with an embodiment of the invention; and

FIG. 2 is an enlargement of FIG. 1.

### DETAILED DESCRIPTION OF THE PREFERRED EMBODIMENTS

A root destroyer system in accordance with preferred embodiments of the invention can be formulated with a herbicidal ingredient, a foaming surfactant system and/or a bacteria system. Other components, such as a tackifier, which aids the active ingredients in adhering to the root parts, or inert fillers, which helps to disperse the active ingredients more uniformly, can also be added for improved efficacy.

Herbicides that can be used in the composition can either be heavy metal based herbicides or organic herbicides and combinations thereof. Copper sulfate is an example of a heavy metal herbicide. Dichlobenil is an example of an organic based herbicide. The preferred herbicide is dichlobenil. The herbicides advantageously comprise about 0.1 to 2%, preferably 0.5% to 1%, by weight of the total dry composition.

In addition, a bacterial component can be included. This component can either be in sold or liquid form. Microorganisms that can be used in the formulated root destroyer system can be any beneficial aerobic microbial organism or combination of organisms known to control algae, weeds, and/or organic pollutants, and which can survive and function in the aqueous medium provided by bodies of water in the sewer discharge pipe containing the active herbicide. Examples of suitable bacteria include bacteria selected from the genus Bacillus, Streptmyces, Arthrobactes and Pseudomonas, which produce lignocellulase enzymes capable of degrading roots and organic matter.

Bacteria in accordance with the preferred embodiments of the invention have been adapted by natural selection or mutation to be resistant to herbicides and to survive during use of the root destroyer system. Suitable bacteria which can survive in the presence of highly active anti-microbial components have been developed by Organica Inc. of Norristown, Pa., using the Gradient Plate Method. The Gradient Plate Method is a classic method used to select and cultivate bacterial strains with desired characteristics. Strains were cultured in an aqueous environment rich in metallic herbicides, such as copper sulfate, or organic herbicides, such as dichlobenil. Mutant cultures that were capable of surviving the harsh conditions and still express the desired enzymes were repeatedly grown in increasing concentrations of herbicide until a culture resistant to the herbicide was produced.

Examples of strains that can be used in the Gradient Plate Method for this invention include, but are not limited to, the following: Bacillus subtilis, Bacillus coagulans, Bacillus sphericus, Bacillus megaterium, Bacillus licheniformis, Bacillus thurirgensis, Bacillus steareothermophilus, Bacillus polymyxa, Bacillus cereus, Bacillus globigi, Bacillus halodurans, Bacillus azotofixans, Bacillus azotoformans, Azotobacter sp., Pseudomonas flourescens, Pseudomonas aureofaciens, Saccharomyces cerevisiae, Arthrobactre sp., Flarobacterirum sp., Streptomyces sp., Aspergillus sp., Trichoderma sp. and other beneficial filamentous fungi.

All of the above microorganisms are well known and are readily available from public depositories including ATCC and NRRL

Preferably, the microorganism will consist of from 1×10³ to 1×10⁹ micro-organisms per gram of the solid form or liquid form composition and more preferably from 1×10⁴ to 1×10⁸ microorganisms per gram of the composition. If stored in liquid media, it should be in a separate container. If solid, the bacteria can be mixed with the other ingredients or separated.

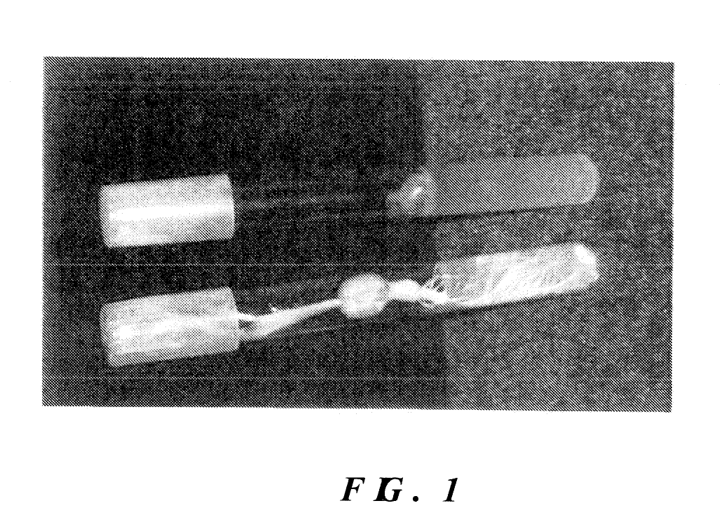

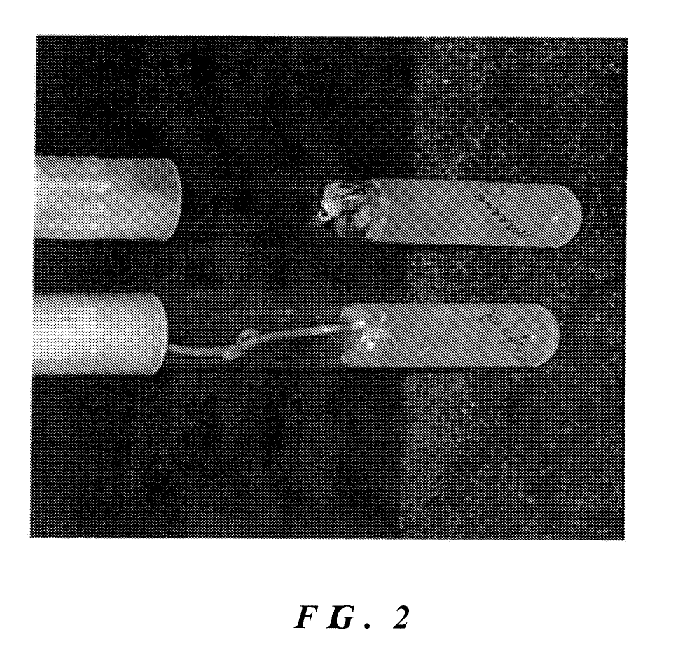

The microorganisms of the invention provide control of algae and weeds for much longer periods of time than is possible with the use of either a herbicide or bacteria component individually. In addition, the compositions provide more complete and faster control of the algae and weeds, and are quite effective in preventing secondary algae. Both long and short term exposure of roots typified by the mung bean or the nut bean are shown in FIGS. 1-2.

A preferred embodiment of the invention can also contain bacterial growth accelerators, which are organic and inorganic compounds that accelerate the growth and reproduction of the microorganisms. Such growth accelerators include carbon sources such as dextrose, sucrose, molasses; combined carbon and nitrogen sources such as soy proteins, milk amino acids, yeast extracts; trace elements such as trace metals; and vitamins. In addition, some of the binders and other components used to prepare the finished solid compositions may also serve as growth accelerators for the microorganisms. The growth accelerator can constitute 1-2% of the total composition, preferably 0.05%. Any quantity of growth accelerator can be present that will effectively accelerate the growth of the microorganisms when the composition is added to a natural body of water.

The composition can also include surfactants. The surfactant system preferably represents about 5-15%, preferably 10%, most preferably about 7.5%, by weight of the root destroyer composition.

A preferred blend can contain 1-10% each of sodium lauryl sulfate alkanolamide and amido sulfonate. An example of the dry sodium lauryl sulfate is Stepan ME dry, manufactured by Stepan Chemical Company of Chicago, Ill. An example of the alkanolamides is Ninol 96-SL by Stepan Company. An example of amid sulfonates is Adinol OT-64, also by Stepan Chemical Company. The combination of surfactants is designed to generate and sustain a foam head through mechanical agitation or mixing of flushing. The height and longevity of the foam has been measured by both a laboratory technique utilizing the Ross-Miles Foam Test as well as utilizing a test stand involving a toilet with a clear 4-inch inner diameter PVC discharge pipe running the length of approximately 50 feet. The latter tests are conducted by dissolving a single eight ounce water soluble bag in accordance with an embodiment of the invention, dissolving in water after two minutes and then proceeding to flush the toilet. The formulation under these conditions generates a head foam suitable to space fill the 2-4 inch waste discharge pipe.

Other ingredients, such as filler can be added. Filler, representing about 90%, preferably 88%, by weight of the root destroyer composition, can be included. Suitable filler include sodium bicarbonate and kaolin clay, preferably about 30-90% kaolin clay and 0-50% sodium bicarbonate, most preferably 40-80% kaolin clay and 10-40% sodium bicarbonate.

The preferred embodiment can also include a tackifier. The preferred type of tackifier belongs to the family of hydrocolloids. An example of the preferred tackifier is represented by Kelzan T provided by Biopolymers of Chicago, Ill.

A nonlimiting illustrative example composition in accordance with an embodiment of the invention is illustrated in the following table.

| COMPONENT | WEIGHT PERCENT |
|---|---|
| Sodium Bicarbonate | 28.3 |
| Kaolin Clay | 60 |
| Stepanol ME Dry | 2.5 |
| Ninol 96-SL | 2.5 |
| Adinol OT-64 | 2.5 |
| Barrier 50W | 1.13 |
| Biolignin | 3 |
| Kelzan T | 0.1 |

The composition was used in experiments to show the effectiveness of the preferred embodiment by submerging and comparing mung bean growth in agar with and without exposure to the composition. As can be seen from FIG. 1 and FIG. 2, after 24 hours, mung beans exposed to the example composition had relatively small growth in comparison to mung beans growing in agar alone.

It will thus be seen that the objects set forth above, and those made apparent from the preceding description, are efficiently attained and, since certain changes may be made in the above construction without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Particularly, it is to be understood that in said claims, ingredients or compounds recited in the singular are intended to include compatible mixtures of such ingredients whenever the sense permits.

1-26. (canceled)

27. A root destroyer composition comprising:
an herbicidal component;
a bacterial component comprising bacteria which are resistant to the herbicidal component and are obtained by sequential culturing in an aqueous environment containing herbicides; and
a foam-producing system.

28. The composition of claim 27, wherein the herbicidal component comprises dichlobenil or copper sulfate.

29. The composition of claim 27, wherein the herbicidal component comprises dichlobenil at a concentration of about 0.1% to about 2% by weight of the composition.

30. The composition of claim 27 comprising effective amounts of bacterial growth accelerator to induce growth and reproduction of the bacteria.

31. The composition of claim 27, wherein the foam-producing system comprises a blend comprising by weight of the composition about 1% to about 10% sodium lauryl sulfate, about 1% to about 10% alkanolamide, and about 1% to about 10% amido sulfonate.

32. The composition of claim 27 comprising a filler selected from one or more of kaolin clay and sodium bicarbonate.

33. The composition of claim 27 comprising a filler, wherein the filler comprises by weight of the composition about 40% to about 80% kaolin clay and about 10% to about 40% sodium bicarbonate.

34. The composition of claim 27 comprising a tackifier, wherein the tackifier comprises a hydrocolloid.

35. A method of destroying root mass in an underground drain system, the method comprising:
introducing the composition of claim 27 into a toilet by flushing the toilet to cause the composition to create foam extending over an entire waste pipe cross-section from the toilet;
contacting a root mass in a drain pipe with the composition; and
killing at least a part of the root mass.

36. The method of claim 35, wherein the composition is packaged in a water-soluble container.

37. The method of claim 35, wherein the herbicidal component in the composition comprises dichlobenil or copper sulfate.

38. The method of claim 35, wherein the herbicidal component in the composition comprises dichlobenil at a concentration of about 0.1% to about 2% by weight of the composition.

39. The method of claim 35, wherein the composition comprises effective amounts of bacterial growth accelerator to induce growth and reproduction of the bacteria.

40. The method of claim 35, wherein the foam-producing system in the composition comprises a blend comprising by weight of the composition about 1% to about 10% sodium lauryl sulfate, about 1% to about 10% alkanolamide, and about 1% to about 10% amido sulfonate.

41. The method of claim 35, wherein the composition comprises a filler selected from one or more of kaolin clay and sodium bicarbonate.

42. The method of claim 35, wherein the herbicidal component and the foam-producing system in the composition are provided as a dry blend, and wherein the foam-producing system is formulated so that when flushed in a conventional tank-based toilet that flushes five gallons per flush, sufficient foam is generated to contact the entire inner surface of a 2-4 inch inner diameter, 50-foot long discharge pipe with the herbicidal component.
